(19) United States
(12) Patent Application Publication
(10) Pub. No.: US 2012/0240708 A1
(43) Pub. Date: Sep. 27, 2012

(54) Power Transfer Box Spline Lubrication Device

(76) Inventor: Danny G. Voth, Liberty, KS (US)

(21) Appl. No.: 13/052,364

(22) Filed: Mar. 21, 2011

(51) Int. Cl. F16H 57/04; F16H 57/00

(52) U.S. Cl. 74/467; 74/640

(57) ABSTRACT

A power generating device and a power transfer device. The power transfer device is coupled to the power generating device. The power transfer device includes at least one rotating component having an opening through which an axis runs. The rotating component is rotatable about the axis. The rotating component has an engaging feature facing the axis. A plug is positioned in the opening with a hole through the plug.

### FIELD OF THE INVENTION

The present invention relates to a power transfer box lubrication device, and, more particularly, to a gearbox spline lubrication device.

### BACKGROUND OF THE INVENTION

Power transfer devices, such as a transmission or a pump drive gearbox typically lubricate the gears by at least one of the gears being partially submerged in a reservoir of lubricating oil, causing the oil to be splashed about the interior portions of the box. There can even be protrusions from portions of the gear to cause more oil to splash about the interior of the gearbox. This is a random type of lubrication that has been utilized in many power transmission type devices with the assumption that the lubrication will eventually get to the needed places by it being randomly splashed about the interior of the gearbox and onto the moving parts therein.

Broadly, a gearbox can be thought of as a device that converts rotational speed and torque into another speed and torque and is often utilized in vehicles powered by an engine that provides a rotational torque source of power where the gearbox alters the speed and torque output to a desired level. Gearboxes are also used in a wide variety of stationary applications such as wind turbines. Gearboxes are also used in agricultural, industrial, forestry, construction, mining, as well as automotive equipment. Gearboxes can be thought of as a simple type of transmission often used to reduce speed or provide a change in direction of the rotating power. Usually, the distinction is that a gearbox has a gear ratio that does not change during use and is fixed at the time the gearbox is constructed. In contrast to the construct of a gearbox, a transmission has the capability to select different gear ratios.

Gearboxes often will have at least one splined fitting where a splined shaft interacts with a gear that has an internal spline that corresponds to the splined shaft. The lubrication of the spline is needed to prevent fretting of the spline. This is difficult when the splines are spinning at a high speed.

What is needed in the art is a system to more efficiently lubricate the splines in a gearbox to allow for the more efficient running of the gearbox at a lower temperature.

### SUMMARY OF THE INVENTION

The present invention provides a power transfer device with a lubrication system directing lubricant into the splines of interacting, rotating parts.

The invention, in one form thereof, is directed to a vehicle including a power generating device and a power transfer device. The power transfer device is coupled to the power-generating device. The power transfer device includes at least one rotating component having an opening through which an axis runs. The rotating component is rotatable about the axis. The rotating component has an engaging feature facing the axis. A plug is positioned in the opening with a hole through the plug.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a side view of vehicle using a gearbox that has an embodiment of a spline lubrication device of the present invention;

FIG. 2 is a partial cross section perspective view of the gearbox used by the vehicle of FIG. 1; and,

FIG. 3 is an expanded side view looking back through the plug utilized to enhance lubrication of the splined shaft and gear of the gearbox of FIG. 2.

### DESCRIPTION OF THE PREFERRED EMBODIMENT

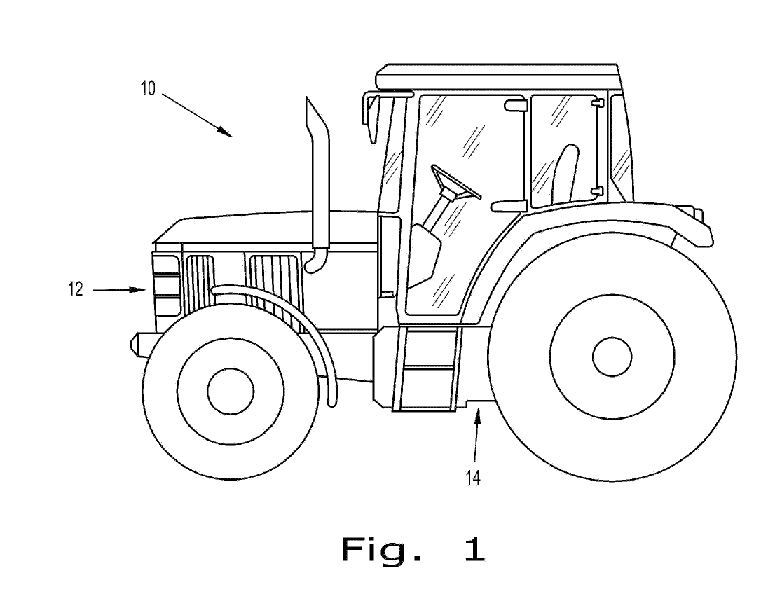

Referring now to the drawings, and more particularly to FIG. 1, there is shown a vehicle 10 having a power generating device 12 and a power transfer device 14. Vehicle 10 is shown as an agricultural vehicle, although it is recognized that other vehicles, such as construction vehicles, forestry vehicles, industrial vehicles, mining vehicles and the like can be platforms that incorporate an embodiment of a gearbox of the present invention. Power generating device 12 may be a diesel engine that provides mechanical rotary motion to power transfer device 14. Power transfer device 14 may be a gearbox or other similar device having rotating gears therein for the purpose of transferring torque and converting it to a different speed and/or direction.

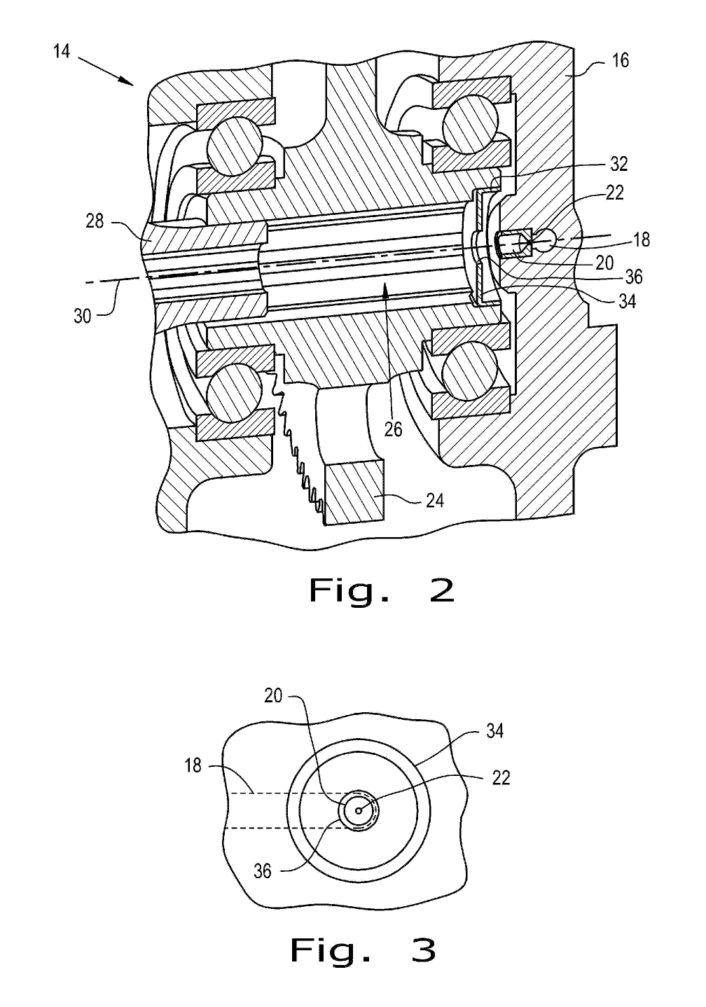

Now, additionally referring to FIGS. 2 and 3, there is illustrated details of power transfer device 14, which include a housing 16, having a lubrication passage 18 therein. Lubrication passage 18 is in fluid communication with lubrication cavity 20 and spray nozzle 22. Fluid passing through lubrication passage 18 then flows first through spray nozzle 22 and then lubrication cavity 20 as it is directed towards a rotating component 24, which may be a gear and, more specifically, to an interior splined opening 26 of rotating component 24. Spray nozzle 22 may be a machined opening to lubrication passage 18. Lubrication cavity 20 serves to protect spray nozzle 22 and to focus the fluid lubricant emanating from spray nozzle 22. Further, lubrication cavity 20 allows the lubrication stream to be somewhat shielded from the movement of air currents within housing 16.

Interior splined opening 26 is an engaging feature that engages splined shaft 28 having a corresponding splined pattern thereon. Please note that splines are utilized for illustration and, although normally used, the present application is directed to engaging features that allow linear or quasi-linear motion along an axis about which the parts are rotating.

An axis 30 defines the rotational axis of rotating component 24, which corresponds to the rotational axis of splined shaft 28. Axis 30 also generally corresponds to the orientation of lubricant coming from spray nozzle 22 and lubrication cavity 20 as it is directed toward the interaction of splined shaft 28 with interior splined opening 26. At one end of interior splined opening 26, there is a counterbore 32, which is sized so that plug 34 may frictionally engage counterbore 32 to be retained therein. Plug 34 is symmetrical, having a cup-like shape with a hole 36 centrally located therein. Hole 36 located in plug 34 is positioned in the end of interior splined opening 26 such that lubricant emanating from spay nozzle 22 and lubrication cavity 20 are directed generally through hole 36 so that lubricant is supplied to the interaction of splined shaft 28 and interior splined opening 26.

Splined shaft 28 can slide in the direction of axis 30 while rotating component 24 and splined shaft 28 are rotating and the lubricant contained therein helps prevent any fretting of the splines. There is a distance between hole 36 and lubrication cavity 20 so that, if lubricant were to substantially fill the open cavity defined by plug 34, interior splined opening 26 and splined shaft 28, that oil can exit back through hole 36. Additionally, in the event that splined shaft 28 slides towards plug 34, oil may be forced back through hole 36. The positioning of plug 34 in counterbore 32 thereby provides a lubricant dam in which lubricant entering through hole 36 will, by centrifugal force, be thrown against the wall of interior splined opening 26 with the lubricant moving generally between splined shaft 28 and interior splined opening 26 to keep the interaction well-lubricated.

Looking at FIG. 3, this is an idealized view looking through plug 34 and hole 36 as if gear 24 was not there. Spray nozzle 22 is substantially concentrically located relative to both lubrication cavity 20 and hole 36 of plug 34. Lubrication passage 18 is shown in fluid communication with nozzle 22 and lubrication cavity 20. Even though there is a space between housing 16 and gear 24, and hence also with lubrication cavity 20, interior splined opening 26 receives lubrication fluid that passes through lubrication passage 18, so even interior splined opening 26 can be considered as being in fluid communication with lubrication passage 18. Counterbore 32 is machined into the back of rotating component 24 and plug 34 can be considered to be a soft plug with a hole 36 therein. Lubricant is sprayed through hole 36 passes through plug 34 in the splined area. Plug 34 traps the lubricant oil and forces it to go through the splines by way of centrifugal head pressure created by the rotation of the parts. This advantageously eliminates, or at least minimizes, spline fretting in high rotational speed splines. Additionally, it eliminates the need for complex machining and/or seals on or around the outside of the spline area to force lubrication into the spline. Further, the present invention eliminates backpressure in the lubrication system from the application of oil through the outside diameter area of the spline.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

The invention claimed is:

1. A vehicle, comprising:
a power generating device; and,
a power transfer device coupled to said power generating device, said power transfer device including:
at least one rotating component having an opening through which an axis runs, said rotating component rotatable about said axis, said rotating component having an engaging feature facing said axis; and,
a plug positioned in said opening, said plug having a hole therethrough.

2. The vehicle of claim 1, wherein said power transfer device further includes a shaft inserted into another part of said opening opposite where said plug is positioned.

3. The vehicle of claim 2, wherein said shaft is engaged by and driven by said engaging feature.

4. The vehicle of claim 3, wherein said engaging feature is a splined feature, said shaft having a corresponding spline interacting with said splined feature.

5. The vehicle of claim 4, wherein said power transfer device further includes a lubrication spray nozzle directing a lubricant through said hole.

6. The vehicle of claim 1, wherein said power transfer device further includes a lubrication passage directing a fluid lubricant through said hole.

7. The vehicle of claim 6, wherein said plug is symmetrical being cup shaped having said hole centrally located.

8. The vehicle of claim 6, wherein said opening has a counterbore into which said plug is frictionally constrained.

9. The vehicle of claim 8, wherein said lubrication passage directed toward said hole is substantially aligned with said axis.

10. The vehicle of claim 9, wherein said power transfer device further includes a housing in which said lubricant is located, said lubrication passage directed toward said hole has a cavity emanating from said lubrication passage and directed toward said hole in said plug.

11. A power transfer device comprising:
at least one rotating component having an opening through which an axis runs, said rotating component rotatable about said axis, said rotating component having an engaging feature facing said axis; and,
a plug positioned in said opening, said plug having a hole therethrough.

12. The power transfer device of claim 11, further comprising a shaft inserted into another part of said opening opposite where said plug is positioned.

13. The power transfer device of claim 12, wherein said shaft is driven by said engaging feature.

14. The power transfer device of claim 13, wherein said engaging feature is a splined feature, said shaft having a corresponding splined feature interacting with said engaging feature.

15. The power transfer device of claim 14, further comprising a lubrication spray nozzle directing a lubricant through said hole.

16. The power transfer device of claim 11, wherein said plug is symmetrical being cup shaped having said hole centrally located.

17. The power transfer device of claim 16, further comprising a lubrication pressurization device that feeds said lubricant into a portion of said lubrication passage.

18. The power transfer device of claim 16, wherein said opening has a counterbore into which said plug is frictionally constrained.

19. The power transfer device of claim 18, wherein said lubrication passage directed toward said hole is substantially aligned with said axis.

20. The power transfer device of claim 19, further comprising a housing in which said lubricant is located, said lubrication passage directed toward said hole has a cavity emanating from said lubrication passage and directed toward said hole in said plug.
